(19) United States
(12) Patent Application Publication
(10) Pub. No.: US 2023/0031245 A1
(43) Pub. Date: Feb. 2, 2023

(54) ENCODER CHANGES

(71) Applicant: Teradici Co., Burnaby (CA)

(72) Inventors: Peter William Longhurst, Vancouver (CA); Joseph Michel Kenneth Savage, Vancouver (CA)

(21) Appl. No.: 17/845,834

(22) Filed: Jun. 21, 2022

Related U.S. Application Data
(60) Provisional application No. 63/225,037, filed on Jul. 23, 2021.

(51) Int. Cl. G06T 9/00; G06T 1/20; H04N 19/196; H04N 19/103; H04N 19/146; H04N 19/132; H04N 19/186

(52) U.S. Cl. CPC G06T 9/00; G06T 1/20; H04N 19/196; H04N 19/103; H04N 19/146; H04N 19/132; H04N 19/186; G06T 2200/16

(57) ABSTRACT

Examples of methods are described. In some examples, a method includes evaluating, by an electronic device, resource state information based on a policy. In some examples, the method includes determining, by the electronic device, to change from a second encoder to a first encoder based on the evaluation. In some examples, the first encoder is to encode a desktop display image sequence. In some examples, the method includes communicating, by the electronic device, the encoded desktop display image sequence.

### RELATED APPLICATION

This application is related to and claims priority to U.S. Provisional Patent Application No. 63/225,037, entitled “Display Processing Method and Apparatus,” filed on Jul. 23, 2021.

### BACKGROUND

The use of electronic devices has expanded. Computing devices are a kind of electronic device that include electronic circuitry for performing processing. As processing capabilities have expanded, computing devices have been utilized to perform more functions. For example, a variety of computing devices are used for work, communication, and entertainment. Computing devices may be linked to a network to facilitate communication between computing devices.

### BRIEF DESCRIPTION OF THE DRAWINGS

FIG. 1 is a block diagram illustrating an example of a system for encoder control;

FIG. 2 is a flow diagram illustrating an example of a method for encoder changes;

FIG. 3 is a flow diagram illustrating an example of a method for managing the coordinated engagement and disengagement of encoders;

FIG. 4 is a state diagram illustrating an example of encoding states;

FIG. 5 is a state diagram illustrating examples of chroma sampling states;

FIG. 6 is a state diagram illustrating examples of encoding states;

FIG. 7 is a state diagram illustrating examples of encoding states;

FIG. 8 is a diagram illustrating an example of a dual display setup;

FIG. 9 is a diagram illustrating an example of a display setup; and

FIG. 10 is a block diagram illustrating an example of a computer-readable medium for encoder changes.

### DETAILED DESCRIPTION

Some examples of techniques for encoding computer desktop display images for remote computing environments utilize lossy video encoders (e.g., H.264, High Efficiency Video Codec (HEVC) video compression, etc.) or purpose-built hardware encoders or programmed encoders that integrate combinations of content-dependent compression technologies such as progressive refinement encoding, build-to-lossless encoding, lossless text encoding, lossy image encoding (e.g., Joint Photographic Experts Group (JPEG) compression) or lossless image compression (e.g., Portable Network Graphics (PNG) compression). Some encoding techniques may be subject to performance trade-offs that limit the techniques' scope of utility. For example, a hardware-based lossy video codec may provide network bandwidth and processing efficiency at the expense of accuracy in image reproduction, whereas a purpose-built progressive refinement encoder may offer higher image reproduction accuracy at the expense of network bandwidth consumption. Accordingly, enhancements to desktop display encoding may expand the usefulness of remote computing environments.

Some examples of the techniques described herein may relate to encoding and/or transmitting a desktop display image sequence using complementary reversible transform and video encoders. For instance, a repeated sequence may be performed, including i) evaluating resource state information based on a mode policy(ies), ii) determining a mode change to enhance a resource state, iii) engaging a first of the complementary encoders to encode the desktop display image sequence, iv) synchronous disengaging of the second of the complementary encoders, and/or v) transmitting the encoded desktop display image sequence to a client device via an Internet Protocol (IP) network.

An operating environment is a program that provides an interactive interface. For instance, a program may be executed on a computing device to provide an operating environment, which may allow interaction with the computing device (e.g., launching an application, displaying media, utilizing a productivity application, etc.). Examples of operating environments may be provided by Microsoft Windows® (e.g., Windows 7, Windows 10, Windows 11, etc.), Unix®, Linux®, macOS®, iOS®, Android™, etc.

A virtualized operating environment is an operating environment that is provided from a host device. For example, a virtualized operating environment may be hosted by a host device (e.g., remote computing device) and/or a stream (e.g., images, frames, etc.) of an interactive interface of a virtualized operating environment may be transmitted to a client device (e.g., local computing device) from the host device via a network(s). For instance, a virtualized operating environment may be transmitted to a client device by providing an interactive interface of the virtualized operating environment over a network. In some examples, the term “remote” may denote that an item is separate from another item, is connected to another item across a network or networks, is in a different area (e.g., room, building, etc.) than another item, and/or is located beyond a distance (e.g., one inch, one foot, one meter, one mile, etc.) from another item.

In some examples, a virtualized operating environment may be provided over a network(s) using a protocol(s). Examples of protocols that may be utilized to provide a virtualized operating environment may include Personal Computer over Internet Protocol (PCoIP), Remote Desktop Protocol (RDP), Independent Computing Architecture (ICA) protocol, Remote Frame Buffer (RFB) protocol, etc. In some examples, an input or inputs obtained at a client device may be sent to a host device. Examples of an input may include a video feed (e.g., frames from an image sensor, camera, web cam, etc.), cursor input (e.g., input from a mouse, touchpad, and/or touchscreen, etc.), keyboard input, etc. The host device may render a desktop display image sequence (e.g., images, frames, etc.) of the virtualized operating environment and may send the stream to the client device. In some examples, the host device may compress the stream.

Throughout the drawings, similar reference numbers may designate similar or identical elements. When an element is referred to without a reference number, this may refer to the element generally, with and/or without limitation to any particular drawing or figure. In some examples, the drawings are not to scale and/or the size of some parts may be exaggerated to more clearly illustrate the example shown. Moreover, the drawings provide examples in accordance with the description. However, the description is not limited to the examples provided in the drawings.

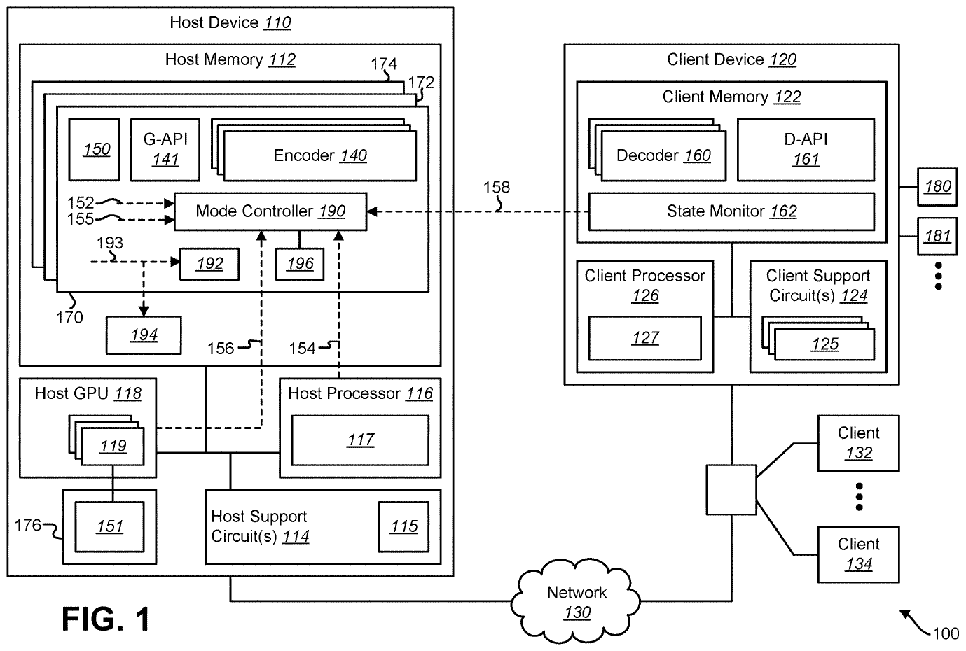

FIG. 1 is a block diagram illustrating an example of a system 100 for encoder control. The system 100 includes a host device 110 and a client device 120. The host device 110 and the client device 120 may be examples of electronic devices.

An electronic device is a device that includes electronic circuitry (e.g., integrated circuitry, etc.). A computing device is an electronic device that includes a processor and/or logic circuitry. Examples of computing devices may include personal computers, desktop computers, laptop computers, servers, cloud workstations, virtual workstations, tablet devices, smartphones, televisions, game consoles, smart speakers, voice assistants, etc. A computing device may utilize processor(s) and/or logic circuitry to perform an operation or operations. In some examples, computing devices may execute instructions stored in memory to perform the operation(s). Instructions may be code and/or programming that specifies functionality or operation of the circuitry. In some examples, instructions may be stored in memory (e.g., Random Access Memory (RAM), Dynamic Random Access Memory (DRAM), magnetoresistive random-access memory (MRAM), phase change RAM (PCRAM), memristor, non-volatile memory, Read-Only Memory (ROM), Erasable Programmable Read-Only Memory (EPROM), Electrically Erasable Programmable Read-Only Memory (EEPROM), flash memory, volatile memory, etc.).

In some examples, a computing device may be linked to another electronic device or devices using a wired and/or wireless link. For example, a computing device may include a communication interface for linking to an electronic device (e.g., switch, router, server, and/or another computing device, etc.). Examples of wired communication interfaces may include an Ethernet interface, Universal Serial Bus (USB) interface, fiber interface, Lightning® interface, etc. In some examples, a computing device may include a wireless communication interface to send and/or receive wireless (e.g., radio frequency (RF)) signals. Examples of wireless communication interfaces may include an Institute of Electrical and Electronics Engineers (IEEE®) 802.11 (WI-FI®) interface, Bluetooth® interface, cellular (e.g., 3G, Long-Term Evolution (LTE®), 4G, 5G, etc.) interface, etc.

A link between electronic devices may be a direct link (e.g., without an intervening device) or an indirect link (e.g., with an intervening device or devices). For instance, a link may be established between electronic devices over a network using a modem(s), router(s), switch(es), hub(s), and/or repeater(s), etc.

A client device is an electronic device capable of receiving communications from a remote device (e.g., host device). For instance, a client device may request and/or receive data, services, etc., from a host device over a network(s) (e.g., Local Area Network (LAN), Wide Area Network (WAN), and/or the Internet, etc.). A host device is an electronic device capable of sending communications to a client device. For instance, a host device may send data, provide services, etc., to a client device over a network(s). In some examples, a host device may be a server and a client device may be an end-user device (e.g., laptop computer, desktop computer, tablet, smartphone, game console, etc.).

In the example of FIG. 1, the host device 110 is linked to the client device 120 via a network 130. Examples of the network 130 may include a local area network (LAN), wireless LAN, wide area network (WAN), and/or the Internet, etc. The network 130 may link electronic devices with a wire, cable, fiber optic, and/or wireless link(s) facilitated by a network element(s) (e.g., hub(s), switch(es), and/or router(s), etc.). In some examples, the network 130 may be a shared packet switched network (e.g., Internet Protocol (IP) packet network) that employs a protocol(s) (e.g., Transmission Control Protocol/Internet Protocol (TCP/IP), User Datagram Protocol/Internet Protocol (UDP/IP), etc.) to communicate information amongst networked devices. For example, the network 130 may include a portion of the Internet. In a virtualized environment such as a virtualized desktop infrastructure (VDI) or desktop-as-a-service (DaaS) deployment, the system 100 may include additional client devices. For instance, the host device 110 may be in communication with a second client device 132 and a third client device 134 via the network 130.

In some examples, the host device 110 may be a computing device or a group of computing devices. The host device 110 may include a host processor 116 (e.g., host central processing unit (CPU)), host memory 112, and/or a host graphics processing unit (GPU) 118. In some examples, the host device 110 may include a host support circuit(s) 114. For instance, the support circuit(s) may include a north bridge, south bridge, power supply(ies), data register(s), and/or network interface(s), etc. The host support circuit(s) 114 may enable communications between elements of the host device 110 and/or communications between the host device 110 and the network 130. While FIG. 1 depicts the host device 110 as including one host processor 116 and one host GPU 118, the host device 110 may include one or multiple host processors 116 (e.g., Xeon Scalable Processor(s), EPYC processor(s), etc.) and/or one or multiple host GPUs 118 (e.g., GPU(s) from NVIDIA or AMD corporations potentially coupled by direct GPU to GPU interconnect). In some examples, the host GPU 118 may include and/or may be coupled to graphics memory 176 (e.g., Double Data Rate Synchronous Dynamic Random-Access Memory (DDRRAM), etc.). For instance, the graphics memory 176 may be coupled to the host GPU 118 by a memory bus. In some examples, the host GPU 118 may be coupled to the host processor 116 by a bus (e.g., Peripheral Component Interconnect Express (PCIe) 3.0, PCIe 4.0, etc.). In some examples, the host processor 116 and the host GPU 118 may be included in (e.g., may be components of) the same physical package (e.g., a processor with integrated graphics from Intel, AMD, or ARM, etc.) and/or may share the same resources, such as the host memory 112.

In some examples, components of the host device 110 may be coupled by a bus(es), interface(s), wire(s), etc. Some examples of the information described herein (e.g., attribute(s) 152, processor state information 154, network state information 155, GPU state information 156, client state information 158, and/or settings 193, etc.) may be communicated via the bus(es), interface(s), wire(s), etc. Some examples of the information described herein (e.g., attribute(s) 152, processor state information 154, network state information 155, GPU state information 156, client state information 158, and/or settings 193, etc.) may be communicated via the network 130.

In some examples, the host memory 112 may include a first memory domain 170. The first memory domain 170 may include a first operating system (OS). For instance, the host processor 116 may execute instructions to provide a first OS in the first memory domain 170. In some examples, the first OS may be utilized to run an application(s) and/or program(s) such as a word processor, spreadsheet application, computer-aided design (CAD) application, visual effects (VFX) application, video editorial application, video player application, etc. In some examples, the first OS may be utilized to generate a user interface. For instance, the user interface may be generated as a source image stored as a set of pixel values in a two-dimensional memory buffer. In some examples, the source image includes pixel values generated by the host processor 116 stored as first source image 150 stored in host memory 112. In a case that the host GPU 118 is engaged for rendering or composition functions, a second source image 151 may be stored in the graphics memory 176 (e.g., stored in a series of image frame buffers). For instance, a first source image 150 and/or a second source image 151 may be produced and/or stored. In some examples, the host processor 116 and host GPU 118 may operate on the same memory domain (e.g., the first memory domain 170) and/or on the same source image (e.g., the first source image 150). As used herein, the term “source image” may refer to a source image generally, to the first source image 150, and/or to the second source image 151.

In some examples, a source image (e.g., first source image 150 and/or second source image 151) may include a host rendered desktop display image, or a host rendered published application display image that is updated in response to user input, application events, and/or OS events. A series of images (with or without updates, for instance) may be referred to as an image sequence. In some examples (VDI, DaaS, etc.), the host memory 112 may include a plurality of isolated memory domains (e.g., first memory domain 170, second memory domain 172 and/or third memory domain 174, etc.), where each memory domain is associated with an independent OS. In some examples, the first memory domain 170 may include the first source image 150 and/or an encoder 140. In some examples, the first memory domain 170, the second memory domain 172, and/or the third memory domain 174, etc., may each include a respective source image and/or respective image encoder, where each OS and/or memory domain may be associated at connection time with a respective client device. In some examples, the host memory 112 may store the first memory domain 170 including the mode controller 190 to control the encoder mode corresponding to the client device 120 and the second memory domain 172 including a second mode controller to control a second encoder mode corresponding to a second client device. In a multi-session example, such as a Remote Desktop Session Host (RDSH) or published application environment, multiple profiles or applications may share the resources of the first memory domain 170, each profile having a separate container space including a source image and access to an image encoder. In some multi-session examples, each profile may be assigned to a unique or a shared image encoder.

In some examples, the host processor 116 may perform an image encoding operation(s). Examples of image encoding operations may include color domain transform operations (e.g., color-space conversion between red-green-blue (RGB) and luminance-chrominance-chrominance (YUV) domains), frequency transform operations (e.g., transforms between rasterized spatial domain and spatial frequency domain, such as wavelet or discrete frequency transform (DCT) domains), image quantization operations, and/or entropy encoding operations (e.g., context-adaptive binary arithmetic coding (CABAC), Huffman, Lempel-Ziv (LZW) encoding operations). In some examples, the host processor 116 may include a host single instruction multiple data (SIMD) execution unit 117 (e.g., Streaming SIMD Extension (SSE) 4, SSE 4.2, Advanced Vector Extension (AVX), AVX2, AVX-256 AVX-512, ARM NEON execution unit, etc.) for executing a display image encoding operation(s).

In some examples, the host GPU 118 may include a hardware encoder 119 (e.g., hardware media encoder, hardware video encoder, AMD RAPIDFIRE or Advanced Media Framework (AMF) compatible media encoder, Nvidia Encoder (NVENC), etc.). In some examples, the hardware encoder 119 performs video encoding (e.g., H.264 or Advanced Video Coding (AVC), H.265 or High Efficiency Video Coding (HEVC), AV1, VP9 video encoding, etc.). In some examples, multiple hardware encoders 119 may be included in the host GPU 118. In some examples, a hardware encoder(s) (e.g., QUICK SYNC encoder) may be included in the host processor 116 and/or may be included in the host support circuit(s) 114. In some examples, the hardware encoder 119 may be implemented as a hardware accelerator function such as part of an application specific integrated circuit (ASIC) or field programmable gate array (FPGA) with access to the graphics memory 176.

In some examples, the host support circuit(s) 114 may include network interface (e.g., network interface card (NIC)) resources including processing resources 115. For instance, the processing resources 115 may include Advanced Reduced Instruction Set Computer (RISC) Machine (ARM) processor resources with SIMD and/or media encoder resources enabled to execute partial or complete live image encoding and/or video encoding operations. An example of a NIC with processing resources 115 may be a BlueField NIC.

The encoder 140 may include machine-readable instructions. For instance, the host processor 116 (e.g., host SIMD execution unit 117) may execute the encoder 140 to encode media (e.g., image(s), video, and/or audio). In some examples, the host memory 112 (e.g., first memory domain 170) may include multiple encoders. In some examples, the encoder 140 may be an example of a live encoder. A live encoder is an encoder to encode live content (e.g., content being currently produced). For instance, a live encoder may encode content as the content is captured and/or produced. An example of live content may be a desktop display image sequence, which may be encoded as the desktop display image sequence is being generated and/or produced. In some examples, the encoder 140 instructions may be executed partially or completely by the host processor 116 (e.g., host SIMD execution unit 117), which may consume the first source image 150 (under direction of a mode controller 190, for example) to perform progressive image refinement, lossless image encoding, and/or build-to-lossless techniques. In some examples, the encoder 140 adds error correction (e.g., forward error correction (FEC) codes) to select encoded image frames or low special frequency components (e.g., Low Low (LL) components of a wavelet transform) to provide resiliency over high packet loss networks. In some examples, the encoder 140 may be implemented as a hardware accelerator function such as part of an ASIC and/or FPGA with access to the host memory 112.

In some examples, the host memory 112 may include a graphics application programming interface (G-API) 141. For instance, the G-API 141 may include machine readable instructions including control logic executed partially or completely by the host processor 116 (under direction of the mode controller 190, for example) that engages the hardware encoder 119 (e.g., media encoder) to perform lossy video encoding on the first source image 150 or the second source image 151.

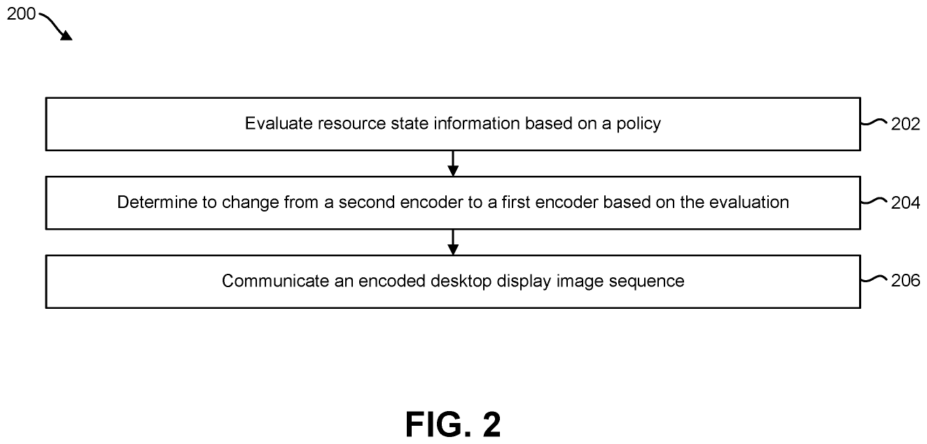

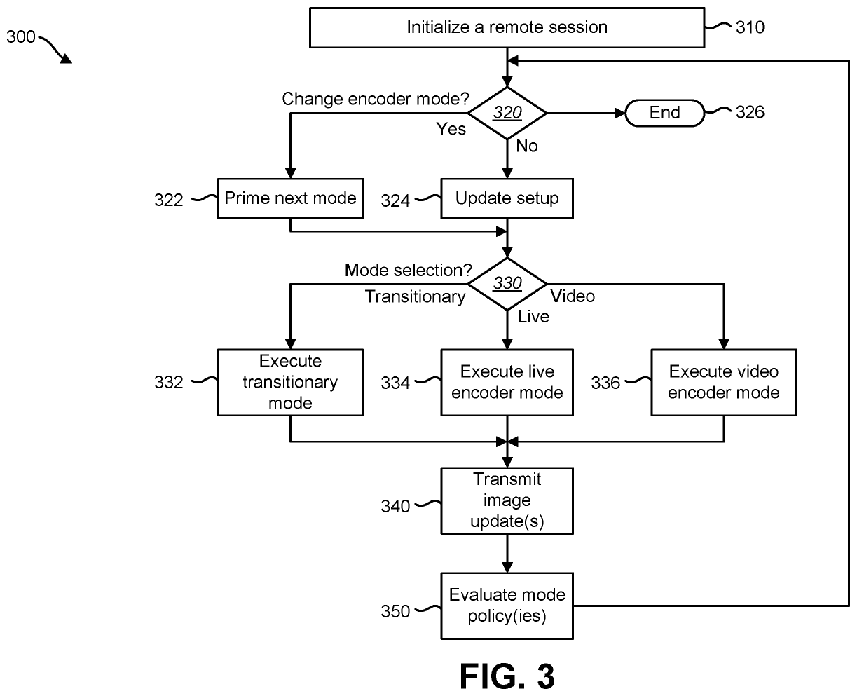

In some examples, the host device 110 may select and/or determine an encoder(s) (e.g., an encoder(s) in the host memory 112 and/or a hardware encoder(s) in the host GPU 118 and/or in the host processor 116) to encode media. For example, the first memory domain 170 may include a mode controller 190 that may be executed to select and/or determine an encoder to encode media. In some examples, the host device 110 may determine to switch between encoders (e.g., between encoders in host memory 112, between hardware encoders, or between an encoder in host memory and a hardware encoder). In some examples, the mode controller 190 includes machine readable instructions executed partially or completely by the host processor 116 to perform an element(s) described in relation to the method 200 of FIG. 2 and/or the method 300 of FIG. 3. In some examples, the mode controller 190 uses a parameter(s) stored in a session policy table 192 to determine the engagement of an encoder in the host memory (e.g., encoder 140) or a hardware encoder (e.g., hardware encoder 119) for an update to the source image. In some examples, the mode controller 190 may determine the engagement of a disengaged encoder (e.g., encoder 140) or a disengaged hardware encoder (e.g., hardware encoder 119) for a future update to the source image (e.g., first source image 150 and/or second source image 151).

The mode controller 190 may evaluate state information based on setup parameters and/or administrator settings to determine mode changes. As used herein, a “mode” refers to a determination and/or utilization of an encoder. In some examples, state information may include an attribute(s) 152 of the source image or an associated application(s) (e.g., an application(s) to produce content of the source image), processor state information 154 pertaining to the host processor 116 (e.g., a processor metric(s) attributed to the encoder 140), network state information 155 pertaining to the network 130, GPU state information 156 pertaining to the host GPU 118 and/or client state information 158 pertaining to the client device 120. Table (1) illustrates some examples of an attribute(s) 152, processor state information 154, network state information 155, GPU state information 156 (e.g., state information of the host GPU 118 and/or hardware encoder 119), and client state information 158. In some examples, components of the host device 110 may be coupled by a bus(es), interface(s), wire(s), etc.

TABLE 1

| | | |
|---|---|---|
| Attribute(s) 152 of | a) | Video content metadata: frame rate (e.g., |
| source image or | | 23.98 ,25, 29.97, 30, 48, 59.94, 60, frames |
| associated | | per second (fps), etc.) |
| application | b) | Video content metadata: chroma format (e.g., |
| | | YUV 4:2:0, 4:2:2, 4:4:4, etc.) |
| | c) | Video content metadata: dynamic range |
| | | format (e.g., 8-bit SDR, 10-bit SDR, high |
| | | dynamic range (HDR) 10 (HDR10), HDR10+, |
| | | hybrid log-gamma (HLG), etc.) and/or |
| | | transfer function (e.g., Perceptual Quantizer |
| | | (PQ)), etc. |
| | d) | Detected source image change rate |
| | e) | Detected source image pixel rate |
| | f) | Application-based processor or GPU |
| | | reservations |
| | g) | Audio attributes (e.g., 5.1, 7.1, Dolby Atmos, |
| | | etc.) |
| Processor state | h) | Active processor utilization |
| information 154 | i) | Active memory bandwidth consumption |
| | j) | Active encoded image pixel rate |
| | k) | Active source image frame drop rate |
| Network state | l) | Active bandwidth (reported by host processor |
| information 155 | | 116, host support circuit(s) 114, encoder 140 |
| | | and/or G-API 141, for example) |
| | m) | Active packet loss (reported by encoder 140 |
| | | and/or G-API 141, for example) |
| GPU state | n) | Active number of source image streams |
| information 156 | o) | Active memory bandwidth consumption |
| | p) | Active encoded image pixel rate |
| | q) | Active source image frame drop rate |
| Client state | r) | Client capabilities information |
| information 158 | s) | Client setup information |
| | t) | Client performance metrics |

| | |
|---|---|
| i) | Active client processor utilization |
| ii) | Active client media decoder utilization |
| iii) | Active memory bandwidth consumption |
| iv) | Active encoded image pixel rate |
| v) | Active client stack frame drop rate |
| vi) | Active client power consumption |

In some examples, settings 193 (e.g., administrative setting(s), setup information, etc.) are a parameter(s) stored in a session policy table 192 and/or a global policy table 194. The settings 193 may be utilized to construct a mode change policy(ies) 196 (e.g., a policy list) that determines mode (e.g., encoder) selection. In some examples, mode decisions are based on determinations local to a particular operating system (e.g., local to a first memory domain 170, second memory domain 172 etc.). In some examples, mode decisions are based (e.g., partially based) on a global determination(s), which may include a parameter(s) stored in the global policy table 194. Examples of settings 193 are provided in Table (2).

TABLE 2

| | | |
|---|---|---|
| Settings 193 in | u) | Encoder reservations |
| session policy table | v) | processor, GPU, and/or network bandwidth |
| 192 | | reservations |
| | w) | Per-display policy(ies) (e.g., target frame |
| | | rate, target image quality) |
| | x) | Per-session policy(ies) (e.g., target frame |
| | | rate, target image quality) |
| | y) | Pixel rate threshold to switch between |
| | | encoders (e.g., between encoder 140 and |
| | | hardware encoder 119) |
| | z) | Bandwidth threshold to switch between |
| | | encoders (e.g., encoder 140 and hardware |
| | | encoder 119) |
| | aa) | Processor utilization threshold to switch |
| | | between encoders (e.g., encoder 140 and |
| | | hardware encoder 119) |
| | bb) | GPU utilization threshold to switch between |
| | | encoders (e.g., encoder 140 and hardware |
| | | encoder 119) |
| | cc) | Packet loss threshold to switch between |
| | | encoders (e.g., encoder 140 and hardware |
| | | encoder 119) |
| | dd) | Client/Host setup |
| Settings 193 in global | ee) | System level reservations |
| policy table 194 | ff) | System metrics |

In some examples, the session policy table 192 may be a datastore local to first memory domain 170 that stores settings 193 associated with encoder modes. In some approaches, the session policy table 192 stores a fixed or adjustable (e.g., programmable) threshold parameter that governs mode transition between live image encoding and video image encoding on a per-display basis. In some examples, the threshold parameter populates a mode change policy in the policy(ies) 196 (e.g., mode change policies) executed at a mode change decision point (e.g., a decision point in the method 300 described in relation to FIG. 3). Some examples of threshold parameters may include a changed pixel rate (e.g., a changed pixel rate determined by a change mask applied to the first source image 150 or the second source image 151), or an active network bandwidth on the network 130 associated with encoded egress data from the encoder 140 or the hardware encoder 119. In some examples, the active network bandwidth may be provided by the encoder(s), the host support circuit(s) 114, and/or as feedback from the client device 120. The changed pixel rate may be measured in megapixels per second (MPPS). An example of a default pixel rate threshold is ten MPPS. The active network bandwidth may be measured in megabits per second (Mbps). An example of a default active network bandwidth threshold is ten Mbps. In some examples, the session policy table 192 stores a pixel rate threshold(s) and/or network bandwidth threshold(s). For instance, an encoder mode change may be triggered when the first of the pixel rate threshold or the network bandwidth threshold is exceeded. In some examples, the session policy table 192 may store another parameter(s) (e.g., another parameter(s) described in relation to FIG. 3).

In some examples, the global policy table 194 may be a globally accessible datastore populated via an administrative console and/or automation logic that stores settings 193 and/or live (e.g., current, most recent, etc.) system metrics for resources outside of the first memory domain 170, thereby enabling the mode controller 190 to augment the policy(ies) 196 with global data derived from the global policy table 194.

The client device 120 may be an electronic device (e.g., computing device) capable of connecting to the network 130 and executing a decoding technique(s) described herein. For example, the client device 120 may be a terminal such as a zero client, thin client, personal computer, MacOS device, a digital signage device, tablet device, etc. The client device 120 may include or be coupled to a peripheral device(s), such as a mouse, keyboard, display(s) (e.g., first display 180 and second display 181) for presenting a Graphical User Interface (GUI). In the example of FIG. 1, the client device 120 includes a client processor 126. In some examples, the client processor 126 may include a client SIMD unit 127 and a client memory 122 coupled by client support circuit(s) 124. The client memory 122 may include a decoder 160. Some examples of the decoder 160 may include a media decoder(s), image decoder(s), audio decoder(s), live decoder(s), etc. In some examples, the client memory 122 may include multiple decoders. In some examples, the decoder 160 may include decoder functions such as lossless decompression and inverse quantization functions complementary to those of the encoder 140 of the host device 110. In some examples, the decoder 160 may engage the client SIMD unit 127 (for processing efficiency, for instance). In some examples, the decoder 160 may be implemented (e.g., partially or completely implemented) as machine executable instructions stored in client memory 122 and executed by the client processor 126. In some examples, the decoder 160 may be implemented (e.g., partially or completely implemented) as a hardware accelerator function such as part of an ASIC and/or FPGA with memory and a display interface.

In some examples, the client support circuit(s) 124 may include a hardware decoder 125 (e.g., hardware media decoder). In some examples, the client support circuit(s) 124 may include multiple hardware decoders. In some examples, the hardware decoder 125 may be integrated as part of a system-on-chip (SoC) decoder and/or incorporated in a discrete graphics processor associated with the client device 120. In some examples, the hardware decoder 125 may be managed via a decoder API (D-API) 161. In some examples, the D-API 161 may deliver video decoder services complementary to the hardware encoder 119, such as H.264, H.265, AV1, and/or VP9 video decoder services. In some examples, video decoder functions may be executed by the client processor 126 as machine readable instructions.

In some examples, the client memory 122 may include a state monitor 162. The state monitor 162 may provide services for determining and presenting client state information 158 to the mode controller 190. Examples of client state information may include client capabilities information provided during session initialization or changed setup and client performance information provided at intervals (e.g., periodic intervals, regular intervals, etc.) or responsive to changed behavior. Client capabilities information may include information such as client processor description (e.g., manufacturer, family, processor generation and number of cores), client processor clock frequency, capacity and setup of client memory 122 (e.g., single or dual channel, etc.), capabilities of the hardware decoder 125 (e.g., listed video decoder services, video decoder specifications, video decoder pixel rate limits, etc.), network interface specifications (e.g., 1 gigabit Ethernet (GbE) capacity, 2.5 GbE capacity, wireless specification, etc.), network interface setup (wired or wireless network interface active for the remote session), client OS, client application setup, client power consumption setup, and/or display topology or capabilities of the client SIMD unit 127. Client performance information may include metrics such as client processor utilization statistics, client battery level metrics, client power consumption metrics, client memory utilization metrics, client memory bandwidth utilization metrics, queued packet or dropped packet metrics, queued, or dropped decoded frame (or partial frame) metrics and/or decoder latency statistics.

FIG. 2 is a flow diagram illustrating an example of a method 200 for encoder changes. The method 200 and/or a method 200 element or elements may be performed by an electronic device (e.g., computing device, client device, host device, etc.). For example, the method 200 may be performed by the host device 110 and/or client device 120 described in relation to FIG. 1.

The electronic device may evaluate 202 resource state information based on a policy. In some examples, evaluating 202 the resource state information may be performed as described in relation to FIG. 1 and/or FIG. 3. For instance, the host device 110 and/or the client device 120 may evaluate attribute(s), processor state information, network state information, GPU state information, client state information, and/or settings, etc., based on a policy.

In some examples, evaluating 202 the resource state information may include evaluating a pixel change rate based on a pixel rate threshold. In some examples, evaluating 202 the resource state information may include evaluating a network bit rate based on a bitrate threshold. In some examples, evaluating 202 the resource state information may include evaluating a host processor utilization based on a host processor utilization threshold. In some examples, evaluating 202 the resource state information may include evaluating a GPU reservation state. In some examples, evaluating 202 the resource state information may include evaluating a client processor utilization based on a client processor utilization threshold. In some examples, evaluating 202 the resource state information may include evaluating a client memory bandwidth utilization based on a client memory bandwidth utilization threshold.

The electronic device may determine 204 to change from a second encoder to a first encoder based on the evaluation. The first encoder may be utilized to encode a desktop display image sequence. In some examples, determining 204 to change encoders may be performed as described in relation to FIG. 1 and/or FIG. 3. For instance, if a threshold is satisfied by the resource state information, the electronic device may switch from the second encoder to the first encoder.

The electronic device may communicate 206 an encoded desktop display image sequence. In some examples, communicating 206 the encoded desktop display image sequence may be performed as described in relation to FIG. 1 and/or FIG. 3. For instance, a host device may transmit the encoded desktop display image sequence via a network and/or a client device may receive a desktop display image sequence via a network.

In some examples, a host device and/or a client device may blend second content associated with the second encoder and first content associated with the first encoder during a transition stage. For instance, a host device may send the second content (e.g., second frames) encoded using the second encoder and the first content (e.g., first frames) encoded using the first encoder during a transition stage (e.g., a period of time, a quantity of frames, etc.). A client device may decode the first content and the second content, and may blend the first content and the second content. In some examples, blending may include temporal dithering and/or a spatial combination of the first content and the second content.

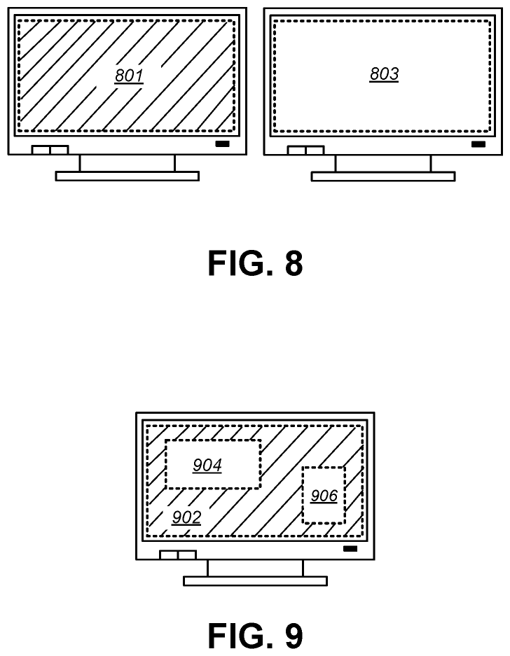

FIG. 3 is a flow diagram illustrating an example of a method 300 for managing the coordinated engagement and disengagement of encoders. In some examples, the method 300 may be performed by the host device 110 (e.g., mode controller 190) described in relation to FIG. 1 to change between the encoder 140 and the hardware encoder 119. In some examples, a two-dimensional (2D) region of a display surface within the scope of an encoder mode may be static or dynamically determined. In some examples, the display surface may extend across multiple physical displays (e.g., first display 180 and second display 181). For instance, FIG. 8 illustrates an example where a first section or portion (e.g., subset) of a source image associated with a first display is managed independently from a second section or portion of the source image associated with a second display. In some approaches, encoder determination may be controlled independently for each physical display (e.g., encoding for each physical display may be independently subject to a mode policy evaluation of the method 300).

In another example illustrated in FIG. 9, a physical display is segmented into regions, where each region may be subject to encoder mode changes on an independent basis. In some examples, content may be segmented into regions using image decomposition techniques and/or by extracting indications from an OS and/or an application that defines characteristics such as window coordinates and/or content attributes of a display region. Examples of characteristics may include window coordinates and content attributes including frame rate, image type (e.g., text, video, natural images, and/or computer-generated lines and patterns, etc.), and/or image quality characteristics such as HDR metadata.

An electronic device may initialize 310 a remote session. For example, a host device and/or a client device may establish a remote session (e.g., remote desktop session, desktop image display session, etc.). In some examples, the remote session may be based on TCP/IP and/or UDP/IP protocols, supported by a peer-to-peer protocol, and/or supported by a client-server protocol (e.g., Web RTC, RDP, Citrix HDX, VMware Blast, Hewlett-Packard (HP) Remote Boost, Mechdyne TGX, Virtual Network Computing (VNC), etc.). In some examples, a policy table(s) (e.g., session policy table 192 and/or global policy table 194) may include default settings. The default settings may be utilized or adjusted (via administrative tools, for instance) prior to remote session establishment. In some examples, default mode change policies may be set up during installation of the mode control instructions, and may be initialized in a remote session establishment sequence.

In some examples, the electronic device (e.g., host device 110, mode controller 190, etc.) initializes a policy(ies) (e.g., policy(ies) 196) according to settings (e.g., settings 193). For instance, initializing the policy list may include establishing a baseline policy based on an MPPS setting. The baseline policy may include a default MPPS threshold used to determine mode changes in response to changes in MPPS measurements. For instance, when a measured MPPS is below the MPPS threshold, a first encoder (e.g., encoder 140) is engaged and when MPPS exceeds the threshold, a second encoder (e.g., hardware encoder 119) is engaged.

In some examples, the policy(ies) 196 (e.g., policy list) is established as a rule(s) based on a logical grouping(s) of settings (e.g., settings in the session policy table 192 and/or settings in the global policy table 194, which may be helpful in virtualized examples). In some examples, each rule may be directed to achieve a target resource efficiency (or resource reservation). Examples of rules (to accomplish target resource efficiency, for instance) may include:
a. IF measured MPPS exceeds MPPS threshold setting OR IF measured bitrate exceeds bitrate threshold, THEN engage video encoder mode (e.g., hardware encoder 119).
b. IF measured MPPS is less than MPPS threshold setting AND IF measured bitrate is less than bitrate threshold, engage live encoder mode (e.g., encoder 140).
c. IF host processor utilization exceeds host processor threshold setting OR IF measured MPPS exceeds MPPS threshold setting, THEN engage video encoder mode.
d. IF host processor memory bandwidth exceeds host memory bandwidth threshold setting, THEN engage video encoder mode.
e. IF host processor utilization is less than host processor threshold setting and MPPS is less than MPPS threshold, THEN engage live encoder mode.
f. IF client processor utilization exceeds client processor threshold setting, THEN engage video encoder mode.
g. IF client memory bandwidth utilization exceeds client memory bandwidth threshold setting, THEN engage video encoder mode.
h. IF GPU memory bandwidth utilization exceeds GPU memory bandwidth threshold setting, THEN engage live encoder mode.
i. IF GPU core utilization exceeds GPU core threshold setting, THEN engage live encoder mode.
j. IF content type is determined as video content, THEN engage video encoder mode.
k. IF content type is determined as text content, AND IF measured MPPS exceeds MPPS threshold, AND IF predicted bitrate exceeds bitrate threshold, THEN:
   i. engage live encoder mode set at a frame rate that matches a maximum bitrate threshold if the predicted frame rate is greater than 25% of the maximum frame rate using the live encoder, OR
   ii. engage the video encoder mode set at a frame rate that matches a maximum bitrate threshold if the predicted frame rate using the live encoder is less than 25% of the maximum frame rate,
l. IF content type is determined as HDR content, THEN engage the video encoder.
m. IF available video encoders are reserved, THEN engage the live encoder.
n. IF the predicted MPPS exceeds an MPPS reservation threshold for GPU, THEN engage the live encoder.
o. IF the client battery state falls below a client battery threshold, THEN engage the video encoder mode
p. IF content has stopped changing during video encoder mode AND the content remains unchanged for a determined time period (e.g., 0.5 seconds, 3 seconds, 5 seconds, 30 seconds, etc.), THEN engage live encoder mode to reencode the most recent frame at a higher image quality

In some examples, a policy(ies) may be prioritized or tuned according to settings and/or according to initial or changed conditions such as network type (wired or wireless), network availability (e.g., 100 megabits per second (Mbps) or 1 gigabits per second (Gbps)), host processor/GPU capability (e.g., processor/GPU benchmark scores), host NIC capability set or client processor capability(ies). In some examples, the client device 120 may establish default client state information (during installation of the state monitor 162, for instance), which may be subsequently initialized with state-dependent values during a remote session establishment sequence. In some examples, client state information 158 may be communicated from the client device 120 to the mode controller 190 of the host device via a management channel of the remote session.

In some examples, a mode controller (e.g., mode controller 190) may establish an initial encoder mode such as engagement of an encoder (e.g., encoder 140) following the session establishment until a quantity of state information is collected to determine a change in mode. In some examples, the initial encoder mode may be established based on settings (e.g., settings 193 in a session policy table 192 and/or in a global policy table 194). For instance, if a global policy table specifies that a hardware encoder (e.g., hardware encoder 119) is currently reserved by another OS domain, another encoder (e.g., encoder 140) may be engaged initially.

The electronic device may determine 320 whether to change an encoder mode. For instance, the electronic device may determine 320 whether an encoder mode change has been indicated during initialization 310 and/or evaluation 350. In some examples, the electronic device may determine whether to change an encoder mode based on resource state information as described in relation to FIG. 1. If the electronic device determines to end the method 300 (e.g., if termination is requested for termination of the remote session), the method 300 may end 326.

If the electronic device determines to change an encoder mode (e.g., if a mode change has been requested), the electronic device may prime 322 a next encoder mode. In some examples, a disengaged encoder may be primed with encoder state information, such as encoder setup (e.g., target image quality and/or chroma sub-sampling setup), current image quality target value (e.g., H.264 quantization parameter (QP) value), encoder bitrate target, network bandwidth target, maximum decoder bitrate, and/or a representation of a display image (e.g., image most recently transmitted to the client device 120).

If the electronic device determines not to change an encoder mode (e.g., if a mode change is not requested), the electronic device may update 324 a setup. In some examples, the setup of the engaged encoder is updated based on changed state information. Updating the setup may enhance efficiency (of a currently engaged hardware encoder 119 or an encoder 140, for instance). In some examples, the setup of the engaged encoder may not be updated (e.g., the update 324 may be skipped). An example of updating a setup is given in FIG. 5.

In some examples of updating a setup (e.g., FIG. 5), the chroma sampling setup of an engaged hardware encoder (e.g., hardware encoder 119) may be updated in response to changes in network availability or changes in content characteristics. For instance, a hardware encoder 119 may be modified from H.264 4:2:0 chroma sub-sampling to H.264 4:2:2 mode if a first network bandwidth availability threshold is detected. In some examples, a hardware encoder 119 may be modified from H.264 4:2:2 chroma sub-sampling to H.264 4:4:4 mode if a second network bandwidth availability threshold is detected. In some examples, the hardware encoder 119 may be modified to more efficient chroma-subsampling modes when reduced network bandwidth availability is detected, for example as indicated by the network state information 155. In some examples, a rapidly changing wireframe image or rapidly scrolled text window may invoke a temporary change from H.264 4:4:4 mode to H.264 4:2:0 mode in response to an MPPS threshold, network bandwidth threshold, and/or GPU resource availability threshold. Examples of GPU resources include encoder utilization, memory bandwidth and GPU core utilization available via statistics interfaces (provided by the G-API 141, for instance).

In some examples, a setup for a maximum image quality setting of an engaged encoder (e.g., encoder 140) is updated from perceptually lossless as a highest image quality setting to numerically lossless as a highest image quality setting in the presence of higher available network bandwidth and vice versa in the presence of reduced available network bandwidth (as indicated by the network state information 155, for instance). In some examples, a disengaged encoder may be primed with a bit depth and color transform of the currently engaged encoder in order to support smooth transition of the decoded image (e.g., reduced visual distortion) during encoder transition using techniques such as image blending or dissolving.

In some examples in which the movement of text is detected, the encoder 140 (e.g., live encoder) may be sustained even if a threshold such as an MPPS threshold is exceeded (as assessed in the evaluation 350), rather than transitioning to the hardware encoder 119 (because chroma sub-sampling video encoders may introduce text distortion). For instance, the setup of the encoder 140 may be updated to maintain live encoding but reduce the frame rate during the movement of the text section. For example, if text motion is detected, rather than encoding the associated image region at 60 fps (which may consume increased network bandwidth, for instance), the region may be encoded at 15 fps, which may maintain visual quality while consuming approximately 25% of the network bandwidth. Examples of text movement include horizontal scrolling, vertical scrolling or dragging a window comprising text content (e.g., mostly text content).

In some examples, an encoder setup may include data (e.g., metadata) derived from and/or stored with an image to be next encoded (the first source image 150, for example). For instance, the data may include information regarding a region(s) of change and/or motion, etc. In some instances, the data may be removed, reset, or invalidated when priming a next encoder mode. In some examples, a record may be maintained of the last image encoded using each encoder mode and priming the next encoder mode may include updating (e.g., correcting) the data based on a delta(s) between the last image encoded by the encoder mode being primed and the next image to be encoded.

The electronic device selects 330 an encoder mode. For instance, the electronic device may select between a transitionary mode, live encoder mode or video encoder mode. If no mode change is determined 320 (e.g., previously determined 320), the electronic device may select the live encoder mode or the video encoder mode to maintain the currently active encoder mode. If a mode change was determined 320 (e.g., previously determined 320), the electronic device may select a transitionary mode or an encoder mode (e.g., live encoder mode or video encoder mode) that is not currently active. In some examples, selecting 330 the encoder mode may include managing a transition timing of engagement and disengagement of the encoders (e.g., between the hardware encoder 119 and the encoder 140), including the timing of a transition period between encoder modes. For instance, the transitionary mode may be engaged over a quantity of frame periods (e.g., a count of 16.6 millisecond frame periods, such as 60 frame periods corresponding to a one second transition period).

In a case that the transitionary mode is selected, the electronic device may execute 332 the transitionary mode. In the transitionary mode, multiple encoders may be engaged concurrently in a transition period. For instance, in a case where network availability is limited, both the hardware encoder 119 and the encoder 140 (e.g., live encoder) may be engaged for a quantity of frames when transitioning from the hardware encoder 119 to the encoder 140. In some examples an encoder (e.g., encoder 140) may encode (for transmission, for instance) an initial image representation in the background including a section(s) of the image representation indicated by a changed pixel map as unchanged since the commencement of the transitionary mode. In some examples, a series of images (e.g., encoded images) may be transmitted as a series of image refinements to a perceptually-lossless or numerically-lossless state, which may be performed without exceeding a target maximum network bandwidth (to avoid causing large traffic bursts associated with immediate lossless encoding of large image sections, for instance). Once the quality of the encoded image generated by an encoder (e.g., the encoder 140, live encoder, etc.) is determined to have the perceptually equivalent quality of the encoded image generated by another encoder (e.g., the hardware encoder 119, etc.), the transitionary mode may terminate.

In some examples, the client device 120 may transition displaying images between decoders. For instance, the client device 120 may transition from displaying an image from a decoder (e.g., hardware decoder 125, etc.) to displaying an image decoded by another decoder (e.g., decoder 160, live decoder, etc.). In an example, if ample network bandwidth is available, the transition from the hardware encoder 119 to the encoder 140 may include a hard cut-over from a final frame using the stream from hardware encoder 119 to a first frame using the stream from the encoder 140.

In some examples, executing 332 the transitionary mode may include controlling blending. For instance, the host device 110 (e.g., mode controller 190) may signal a mode control service installed at the client device 120 to apply blending (e.g., visual dithering) between decoded frames reproduced by the decoder 160 and decoded frames reproduced by the hardware decoder 125 in order to dampen or eliminate visible flicker effects associated with chroma differences between the two image reproductions. For example, the client device 120 may apply 120 hertz (Hz) dithering between two 60 Hz decoded image sequences from the respective decoder 160 and hardware decoder 125 during the transition period to smooth the temporal impact of chroma differences. In another example, frame-blending or dissolving is used over a transition period (e.g., a one second period). In such a case, sections of the source image may be processed by the encoder 140 and the hardware encoder 119, with an increasing proportion of the image encoded by the newly engaged encoder compared to that encoded by the newly disengaged encoder composited at the client device 120 for display over the transition period. In some examples, a technique(s) such as checkerboarding and/or interlacing may be used to achieve spatial blending.

In some examples, a transition from the encoder 140 (e.g., live encoder) to the hardware encoder 119 triggered by an MPPS threshold being exceeded (as a consequence of new video content, for instance) may be less sensitive to network bandwidth availability because the hardware encoder 119 may provide greater network bandwidth efficiency than the encoder 140 for video content. In some examples, the transitionary mode may operate as a temporal hysteresis by determining that a policy threshold such as an MPPS threshold is continually exceeded for a duration (e.g., 2 seconds) and maintaining the encoder 140 for the duration before transitioning to the hardware encoder 119. In some examples, a temporal hysteresis may be enforced in conjunction with an evaluation 350.

If a live encoder mode is selected, the electronic device may execute 334 the live encoder mode. For instance, the hardware encoder 119 may be disengaged and the encoder 140 may be engaged to process an identified region(s) of the source image in scope of encoder mode control (e.g., updated regions of a display or updated regions of a section of a display depending on the scope of mode control).

If a video encoder mode is selected, the electronic device may execute 336 video encoder mode. For instance, the encoder 140 (e.g., live encoder) may be disengaged and the hardware encoder 119 may be engaged to process an identified region(s) of the source image in scope of encoder mode control (e.g., all regions of a display or all regions of a section of a display such as a video player window depending on the scope of mode control).

The electronic device may transmit 340 an image update(s). In some examples, the electronic device may utilize a communication interface to communicate an image update based on the next encoder mode. For instance, the electronic device may transmit 340 the processed image region(s) (e.g., network packets comprising encoded pixels and/or encoded video content) via the network 130 to the client device 120. In some examples, images (e.g., encoded images) received by client device 120 may be decoded by the complementary decoder 160 or hardware decoder 125 as indicated by a stream type identifier in a header of the received encoded image packet.

The electronic device may evaluate 350 a mode policy(ies). For instance, evaluating 350 the mode policy(ies) may include determining whether to i) continue the current encoder mode with a current parameter(s), ii) continue the current encoder mode with an updated parameter(s), iii) change the encoder mode, or iv) end operation (e.g., end the method 300).

In some examples, to reduce (e.g., avoid) unstable toggling between encoder modes, evaluating 350 a mode policy(ies) may incorporate a hysteresis that reduces (e.g., prevents) rapid change between encoder modes or rapid change in setup. In some examples, a hysteresis may be achieved by waiting for a determined quantity of image sequence updates (e.g., 120 frame updates corresponding to two seconds of a particular encoder engagement) before mode policies are evaluated 350 and a mode change is considered.

In some examples, evaluating 350 the mode policy(ies) may include processing the most recent state information (e.g., attribute(s) 152, network state information 155, and/or client state information 158) or predicted state information (e.g., predicted bitrate based on predicted MPPS in conjunction with historic or estimated bits-per-pixel metrics), based on policies established at initialization 310 to determine if a mode change or setup change is to be signaled based on the determination 320. If a setup has changed (e.g., a network setup changed or a resource reservation changed), the policy(ies) may be updated in the evaluation 350. In some examples, an application(s) on the host device 110 may assert resource reservations in the session policy table 192 (on instantiation and/or updated according to an active resource target(s)). For instance, a video editor program (e.g., Premiere, Media Composer, etc.) may assert reservation limits for the hardware encoder 119. In some examples, an application on the client device 120 may assert resource reservations via client state information 158 (e.g., client video encoder and//or decoder reservations by webcam, video conferencing, and/or video editorial application(s)).

In some examples, operation may return to determining 320 whether to change an encoder mode. While the method 300 may be utilized to perform mode control for two encoders (e.g., encoder 140 and hardware encoder 119), the method 300 may be utilized for more than two encoders. For instance, the method 300 may be performed to achieve an encoding objective(s) with two or more encoders. In some examples, another encoder(s) (e.g., HDR encoder, a three-dimensional (3D) content encoder, a lossless text encoder, and/or a PNG format image encoder, etc.) may be incorporated under the mode controller 190 to achieve a policy objective(s) for a particular region of the source image.

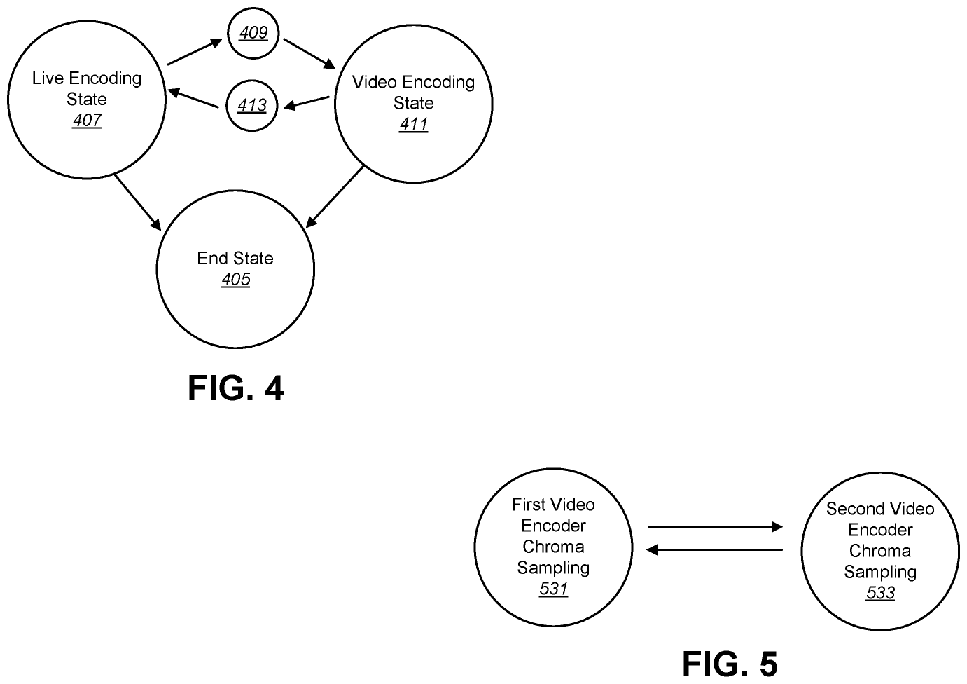

FIG. 4 is a state diagram illustrating an example of encoding states. In some examples, encoding states may be controlled by a host device (e.g., host device 110, mode controller 190). During a live encoding state 407, an encoder 140 (e.g., live encoder) may encode determined sections of the source image which are transmitted over the network 130 and decoded by a decoder 160 (e.g., live decoder). If a hardware encoder 119 (e.g., video encoder) is requested (in the evaluation 350 of the method 300, for instance), a video encoding state 411 may be invoked via a first transition state 409 from the live encoding state 407 to the video encoding state 411. During the video encoding state 411, a hardware encoder 119 may encode the determined sections of the source image that are transmitted over the network 130 and may be decoded by the hardware decoder 125. If, in the video encoding state 411, the encoder 140 is requested (in the evaluation 350 of the method 300, for instance), the live encoding state 407 may be invoked via a second transition state 413 from the video encoding state 411 to the live encoding state 407. The first transition state 409 may prime the hardware encoder 119 with encoding parameters, while the second transition state 413 may prime the encoder 140 with encoding parameters. In some examples, the live encoding state 407 or the video encoding state 411 may transition to an end state 405. For instance, a transition to the end state 405 may occur when a desktop display image sequence is ended (e.g., a remote desktop stream is terminated).

FIG. 5 is a state diagram illustrating examples of chroma sampling states. In some examples, the chroma sampling states may be controlled by a host device (e.g., host device 110, mode controller 190). The chroma sampling states include a first video encoder chroma sampling state 531 and a second video encoder chroma sampling state 533, which may be associated with the video encoding state 411 of the state diagram of FIG. 4. In some examples, the first video encoder chroma sampling state 531 may represent a first chroma sampling mode (e.g., 4:4:4 chroma sampling associated with a H.264 encoder or HEVC encoder, etc.). In some examples, the second video encoder chroma sampling state 533 may represent a second chroma sampling mode (e.g., reduced chroma such as 4:2:0 chroma sampling associated with a H.264 encoder or HEVC encoder, etc.). In some examples (e.g., updating 324 a setup), a hardware encoder 119 may transition between the first video encoder chroma sampling state 531 and the second video encoder chroma sampling state 533 in accordance with the policy(ies) 196.

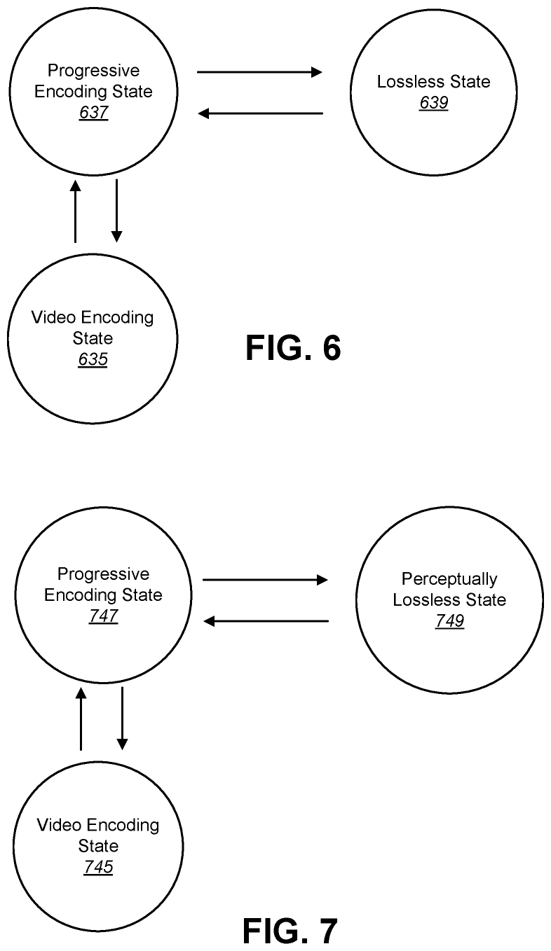

FIG. 6 is a state diagram illustrating examples of encoding states. In some examples, the encoding states may be controlled by a host device (e.g., host device 110, mode controller 190). In some examples, determined sections of the source image may be transmitted over the network 130 and decoded by the client device 120.

The encoding states may include a video encoding state 635, a progressive encoding state 637, and a lossless state 639. In some examples, the video encoding state 635 of FIG. 6 may be associated with the video encoding state 411 of the state diagram of FIG. 4, and the progressive encoding state 637 and the lossless state 639 may be associated with the live encoding state 407 of the state diagram of FIG. 4. When in the video encoding state 635, the hardware encoder 119 may encode determined sections of the source image. When in the progressive encoding state 637, the encoder 140 (e.g., live encoder) may encode the determined sections of the source image. Once the source image has been encoded to a numerically lossless representation such that the image representation at the first display 180 and/or second display 181 are bit-exact representations of the source image, the encoding state may transition to the lossless state 639. If the source image is detected as changed, progressive encoding of the changed regions may be resumed in the progressive encoding state 637. If a policy(ies) determines to resume video encoding, the encoding state may transition to the video encoding state 635.

FIG. 7 is a state diagram illustrating examples of encoding states. In some examples, the encoding states may be controlled by a host device (e.g., host device 110, mode controller 190). In some examples, determined sections of the source image may be transmitted over the network 130 and decoded by the client device 120.

The encoding states may include a video encoding state 745, a progressive encoding state 747, and a perceptually lossless state 749. In some examples, the video encoding state 745 may be associated with the video encoding state 411 of the state diagram of FIG. 4, and the progressive encoding state 747 and the perceptually lossless state 749 may be associated with the live encoding state 407 of the state diagram of FIG. 4. During the video encoding state 745, the hardware encoder 119 may encode determined sections of the source image. During the progressive encoding state 747, the encoder 140 (e.g., live encoder) may encode the determined sections of the source image. Once the source image has been encoded to a perceptually lossless representation such that the image representation at the first display 180 and/or second display 181 meet target quality levels of the source image (e.g., 47 decibel (dB) fidelity), the state may transition to the perceptually lossless state 749. If the source image is detected as changed, progressive encoding of the changed regions may be resumed in the progressive encoding state 747. If a policy(ies) determines to resume video encoding, the state may transition to the video encoding state 745. In some examples, an idle session may occur, where there is no image change for a period (e.g., threshold duration). In some approaches when an idle session occurs, a state transition(s) may include transitioning from a lossy state to a perceptually lossless state, which may be later (e.g., after a time interval) followed by a transition from the perceptually lossless state to a lossless state.

FIG. 8 is a diagram illustrating an example of a dual display setup in which a source image is logically associated with two independent displays. For instance, a first section 801 may be logically associated with the first display 180 in FIG. 1, and a second section 803 may be logically associated with the second display 181 in FIG. 1. In some examples, the first section 801 and the second section 803 may be independently subjected to a mode policy evaluation 350 of the method 300, which may enable, for example, hardware encoder 119 to encode the first section 801 (e.g., video image) concurrently with the encoder 140 (e.g., live encoder) encoding the second section 803 (e.g., text-centric window including menus and/or fine lines).

FIG. 9 is a diagram illustrating an example of a display setup, which may include a single display or a multi-display system. In this example, a source image includes identifiable regions such as a background image 902 and two foreground windows such as a first window 904 (e.g., a window depicting video content) and a second window 906 (e.g., a window depicting mostly text). In some examples, the second window 906 may depict high-fidelity content (identified by high spatial-frequency components), such as text or a wireframe drawing of detailed texture. The first window 904 (e.g., first image) and the second window 906 (e.g., second image) may be independently subjected to a mode policy evaluation 350 of the method 300, which may enable, for example, the hardware encoder 119 to encode a video image of the first window 904 concurrently with the encoder 140 (e.g., live encoder) to encode high-fidelity content of the second window 906. In some examples, the first window 904 and second window 906 (with dynamic content, for instance) may be decomposed from the background image 902, independently encoded, and overlaid on the independently encoded background image 902 at the client device 120. Efficient encoding of the background image 902 (which may be static or subject to slow temporal change, for instance) may involve masking out the decomposed first window 904 and second window 906 (e.g., using low frequency image content prior to tile-wise or frame-wise encoding using the encoder 140).

In some examples, an operation(s) described as performed by a host device (e.g., host device 110) may instead be performed by a client device (e.g., client device 120). For instance, a client device may control an encoder mode and/or encoder selection. In some examples, a client device may evaluate resource state information (e.g., resource state information from the client device, signaled from a host device, any of the parameters described herein, etc.). In some examples, the client device may select an encoder, may determine an encoder mode change, and/or may control an encoding state. The client device may send a message to a host device requesting encoding using the selected encoder and/or determined encoder mode.

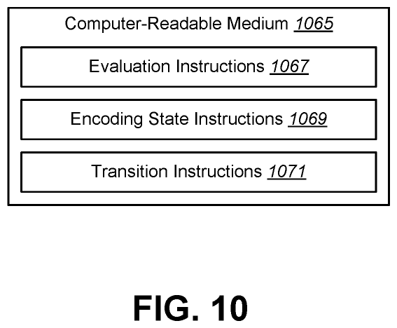

FIG. 10 is a block diagram illustrating an example of a computer-readable medium 1065 for encoder changes. The computer-readable medium is a non-transitory, tangible computer-readable medium 1065. The computer-readable medium 1065 may be, for example, RAM, EEPROM, a storage device, an optical disc, and/or the like. In some examples, the computer-readable medium 1065 may be volatile and/or non-volatile memory, such as DRAM, EEPROM, MRAM, PCRAM, memristor, flash memory, and/or the like. In some examples, the host memory 112 described in relation to FIG. 1 may be an example of the computer-readable medium 1065 described in relation to FIG. 10.

The computer-readable medium 1065 may include data (e.g., instructions, executable code, application(s), program(s), and/or information). For example, the computer-readable medium 1065 may include evaluation instructions 1067, encoding state instructions 1069, and/or transition instructions 1071.

The evaluation instructions 1067 may be executed by a processor to evaluate resource state information based on a policy. In some examples, evaluating resource state information may be performed as described in relation to one, some, or all of FIGS. 1-9.

The encoding state instructions 1069 may be executed by a processor to determine to change a video encoding state. For instance, the processor may determine to change from a video encoding state to a live encoding state to encode a desktop display image sequence. In some examples, determining to change encoding states may be performed as described in relation to one, some, or all of FIGS. 1-9.

The transition instructions 1071 may be executed by the processor to transition between encoding states. For instance, the processor may transition to the live encoding state via a transition state. In some examples, the transition state may include priming an encoder with encoding parameters. In some examples, transitioning between encoding states may be performed as described in relation to one, some, or all of FIGS. 1-9. In some examples, the transition instructions 1071 may be executed by a processor to transition between video encoder chroma sampling states in an encoding state (e.g., video encoding state) as described herein.

As used herein, the term “and/or” may mean an item or items. For example, the phrase “A, B, and/or C” may mean any of: A (without B and C), B (without A and C), C (without A and B), A and B (but not C), B and C (but not A), A and C (but not B), or all of A, B, and C.

While various examples of systems and methods are described herein, the systems and methods are not limited to the examples. Variations of the examples described herein may be implemented within the scope of the disclosure. For example, operations, aspects, and/or elements of the examples described herein may be omitted or combined.

What is claimed is:

1. A method, comprising:
evaluating, by an electronic device, resource state information based on a policy;
determining, by the electronic device, to change from a second encoder to a first encoder based on the evaluation, wherein the first encoder is to encode a desktop display image sequence; and
communicating, by the electronic device, an encoded desktop display image sequence.

2. The method of claim 1, wherein evaluating the resource state information comprises evaluating a pixel change rate based on a pixel rate threshold.

3. The method of claim 1, wherein evaluating the resource state information comprises evaluating a network bit rate based on a bitrate threshold.

4. The method of claim 1, wherein evaluating the resource state information comprises evaluating a host processor utilization based on a host processor utilization threshold.

5. The method of claim 1, wherein evaluating the resource state information comprises evaluating a graphics processing unit (GPU) reservation state.

6. The method of claim 1, wherein evaluating the resource state information comprises evaluating a client processor utilization based on a client processor utilization threshold.

7. The method of claim 1, wherein evaluating the resource state information comprises evaluating a client memory bandwidth utilization based on a client memory bandwidth utilization threshold.

8. The method of claim 1, wherein a client device is to blend second content associated with the second encoder and first content associated with the first encoder during a transition stage.

9. The method of claim 8, wherein blending comprises temporal dithering or a spatial combination of the first content and the second content.

10. An electronic device, comprising:
a processor to:
determine whether to change an encoder mode based on resource state information;
prime a next encoder mode in response to a determination to change the encoder mode to encode a desktop display image sequence; and
a communication interface to communicate an image update based on the next encoder mode.

11. The electronic device of claim 10, further comprising a memory to store a first memory domain including a first mode controller to control the encoder mode corresponding to a first client device and a second memory domain including a second mode controller to control a second encoder mode corresponding to a second client device.

12. The electronic device of claim 10, wherein the processor is to control an encoder determination independently for respective physical displays.

13. A non-transitory tangible computer-readable medium comprising instructions when executed cause a processor of an electronic device to:
evaluate resource state information based on a policy;
determine to change from a video encoding state to a live encoding state to encode a desktop display image sequence; and
transition to the live encoding state via a transition state.

14. The non-transitory tangible computer-readable medium of claim 13, wherein the transition state includes priming an encoder with encoding parameters.

15. The non-transitory tangible computer-readable medium of claim 13, wherein the instructions when executed cause the processor of the electronic device to transition between video encoder chroma sampling states in the video encoding state.
